(19) United States
(12) Patent Application Publication
(10) Pub. No.: US 2005/0282112 A1
(43) Pub. Date: Dec. 22, 2005

(54) Coated dental instruments

(76) Inventor: Ajay Kumar, Palmdale, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/993,207

(22) Filed: Nov. 19, 2004

Related U.S. Application Data
(60) Provisional application No. 60/581,101, filed on Jun. 17, 2004.
(60) Provisional application No. 60/584,322, filed on Jul. 1, 2004.

(51) Int. Cl. A61C 17/06

(52) U.S. Cl. 433/141

(57) ABSTRACT

In one embodiment, a dental instrument comprises an elongate dental tool having a proximal portion, a distal portion, and a cutting portion located near the distal portion. A reduced friction coating is applied to the elongate dental tool at least at the cutting portion.

### PRIORITY INFORMATION

This application is based on and claims priority to U.S. Provisional Patent Application Nos. 60/581,101 (filed Jun. 17, 2004), and 60/584,322 (filed Jul. 1, 2004), the entire contents of each of which are hereby expressly incorporated by reference herein.

### BACKGROUND OF THE INVENTION

1. Field of the Invention

This application relates to dental instruments, and in particular relates to coated dental instruments.

2. Description of the Related Art

In preventive dentistry, it is important to keep teeth clean. Over time, deposits can form on the surface of a tooth below the gum line, e.g., in the periodontal pocket. Calculus is a solid material deposit that bonds to the surface of a tooth over time, and should be removed periodically to maintain healthy teeth. Ultrasonic, sonic and manual teeth cleaning can be used to remove calculus from the surface of a tooth in the periodontal pocket. Stainless steel, titanium and titanium alloy dental scalers having a cutting edge can be used to remove calculus. However, the cutting edge can wear out quickly, can damage the tooth, can fail, and can be difficult to clean.

In another dental application, to preserve a tooth that has diseased pulp, or potentially diseased pulp, it is often necessary to perform a root canal procedure. A root canal preparation can involve pulp removal, cleaning of the root canal walls, and shaping the canal walls. Cavity preparation, including pulp removal, can be performed using one or more instruments, such as, for example, files, bits, burrs, reamers, and end mills. These instruments can be configured to bore and/or cut. The instruments can be moved manually, mechanically, or by some combination of manual and mechanical methods. An endodontic handpiece can be coupled to an instrument to impart rotational motion, reciprocal motion, sonic movements or ultrasonic movements. However, the files, burrs, and other instruments can wear out quickly, can cause damage to the tooth, can fail, and can be difficult to clean. In another dental application, dental burrs and end mills can be used to prepare a titanium dental implant. In some cases, the dental burr has a carbide tip. Unfortunately, during the preparation of some dental implants, the dental burrs can become extremely hot. This can increase the likelihood of thermal bone necrosis.

### SUMMARY OF THE INVENTION

Accordingly, there is a need in the art for systems and methods for enhancing the longevity of dental instruments, increasing their functionality, making it easier to remove organic material, and reducing heat transfer during a procedure.

In one embodiment, a dental instrument comprises an elongate dental tool having a proximal portion, a distal portion, and a cutting portion located near the distal portion. A reduced friction coating is applied to the elongate dental tool at least at the cutting portion.

In one technique, a method for treating a patient comprises providing an elongate dental tool having a proximal portion, a distal portion, and a cutting portion having a reduced friction coating applied to at least the cutting portion. The elongate dental tool is inserted into the mouth of the patient to perform a dental procedure.

In another technique, a method for making a dental instrument comprises providing an elongate dental tool having a proximal portion, a distal portion, and a cutting portion. A reduced friction coating is applied to at least the cutting portion.

In one embodiment, a coating is used on a dental instrument. In one embodiment, the coating is a diamond-like carbon coating. A diamond-like carbon coating, depending on the deposition conditions and the tribological system, can have different outstanding tribological properties. In one embodiment, a diamond-like carbon coating comprises a hydrogenated amorphous carbon (a-C:H). In another embodiment, a diamond-like carbon coating comprises a hydrogen free tetrahedral amorphous carbon (ta-C).

In one embodiment, when a coated scaler slides against a tooth surface, the formation of a transfer layer on a metallic part of the scaler protects the scaler from excessive wear, minimizes damage to the tooth, reduces the likelihood that the scaler will fail, and is easily cleanable. Metals by nature are hydrophilic, which can make cleaning difficult, however, some coatings, e.g., a diamond-like carbon coating, are hydrophobic. In one embodiment, biological tissue does not adhere to a diamond-like carbon coating, so bacteria and viruses are not readily able to cling to the surf ace of the scaler.

In another embodiment, a dental tool having a coating, e.g., a diamond-like carbon coating, has a high thermal conductivity. The coating decreases wear significantly by rapid transfer of heat from hot spots caused by localized frictional heating. In one embodiment, a diamond-like carbon coating has a coefficient of friction of between about 0.05 and about 0.15. In another embodiment, the coefficient of friction can be greater than about 0.15. In another embodiment, the coefficient of friction can be less than about 0.05. In one embodiment, the coating on the tool acts to minimize frictional wear.

### BRIEF DESCRIPTION OF THE DRAWINGS

Further objects, features and advantages of the invention will become apparent from the following detailed description taken in conjunction with the accompanying figures showing illustrative embodiments of the invention, in which:

FIG. 1 is a perspective view of one embodiment of a coated scaler.

FIG. 2 is a perspective view of one embodiment of a coated file.

FIG. 3 is a perspective view of one embodiment of a coated burr.

Throughout the figures, the same reference numerals and characters, unless otherwise stated, are used to denote like features, elements, components or portions of the illustrated embodiments. Moreover, while the subject matter of this application will now be described in detail with reference to the figures, it is done so in connection with the illustrative embodiments. It is intended that changes and modifications can be made to the described embodiments without departing from the true scope and spirit of the subject invention as defined by the appended claims.

### DETAILED DESCRIPTION OF THE PREFERRED EMBODIMENTS

As should be understood in view of the following detailed description, this application is primarily directed to, though not necessarily limited to, coated dental instruments, such as, for example, dental scalers, files, burrs, and reamers used to cut (inside or on the surface), drill and/or clean the natural tooth surface.

### I. Reduced Friction Coated Dental Scalers

Calculus is a rough, porous, and plaque-retentive substance that adheres to the root surface of a tooth. Dental scalers are devices that are used to remove calculus from the a tooth. A scaler can be hand driven and/or mechanically driven (e.g., ultrasonic and sonic) for easy removal of calculus from deep within the periodontal pocket.

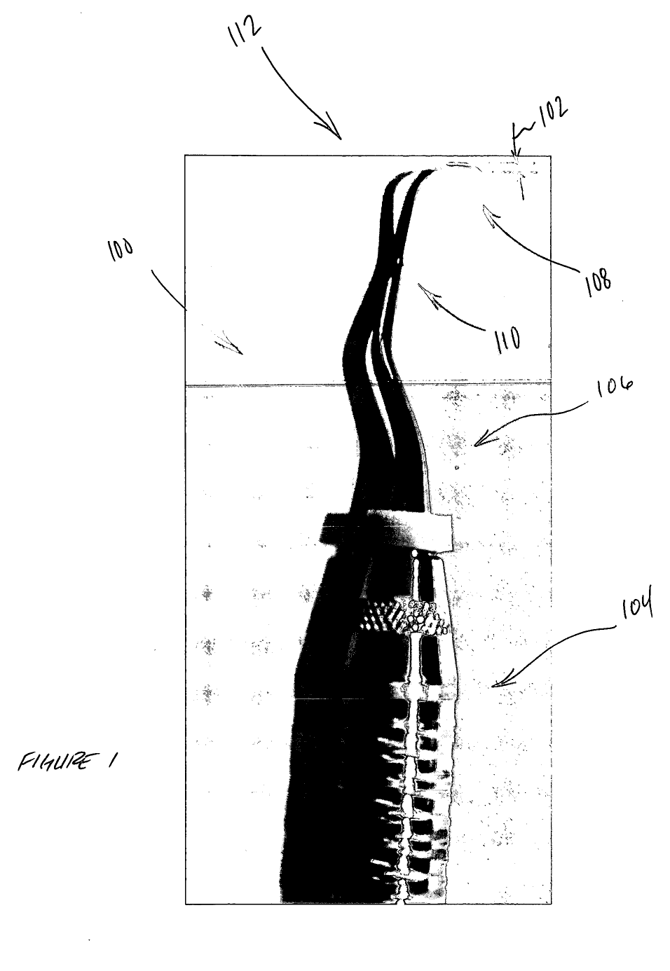

FIG. 1 illustrates an exemplary embodiment a scaler 100. As is typical in the art, the scaler 100 is configured be placed between a tooth and surrounding gum and bone. In this embodiment, the scaler 100 may be vibrated to remove calculus deposits bonded to the tooth without unnecessarily traumatizing the surrounding gum and bone. The scaler 100 also aids in the ability of the dental provider to tactually sense the location of calculus deposits. A fluid spray can be used to aid in cooling the working area and in removing loosened calculus.

As shown in FIG. 1, the dental scaler 100 comprises a handpiece 104 and a tool 106 coupled or attached to the handpiece 104. The tool 106 preferably is positioned adjacent a tooth for use. The tool 106 has a diameter 102 along the length of an abrasive portion 108, e.g., a cutting portion, that is sufficiently small to fit within the periodontal pocket between the gingival, or gum, and the bone. In one embodiment, the diameter 102 of the abrasive portion 108 of the tool 106 preferably is less than or equal to about 0.014 inches. In another embodiment, the diameter 102 of the abrasive portion 108 is greater than or equal to about 0.0065 inches. The tool 106 can have a generally conical shape along a portion of its length. In one embodiment, the 106 tool having the abrasive portion 108 with the diameter 102 of less than or equal to about 0.014 inches advantageously removes calculus from the tooth surface while providing minimal damage to the surrounding tissue and bone. The relatively small diameter 102 of the tool 106 advantageously results in greater flexibility of the tool 106.

In the illustrated embodiment, at least the cutting edge 108 of the dental scaler 100 is coated with a reduced friction coating 110. In one embodiment the reduced friction coating 110 is an amorphous diamond coating. In another embodiment, the reduced friction coating 110 is a Teflon coating. In another still embodiment, the reduced friction coating 110 is a ME-92 coating. In another embodiment, the reduced friction coating 110 is a sputter gold coating, where the gold acts as a solid lubricant. In still other embodiments, Other reduced friction coatings can also be used and/or the coating described above may be combined with each other or with other coatings.

Coating the cutting edge 108 with a reduced friction coating 110 advantageously enhances the longevity of the cutting edge 108 and makes it easier to remove organic material from the cutting edge 108, e.g., during cleaning. Application of the reduced friction coating 110 also improves the cutting efficiency of the scaler 100. These and other advantages will be described further below.

The coating 110 can cover a portion of the scaler 100, such as the cutting edge 108, or it can extend along the whole length of the scaler 100. In one particular embodiment, at least the tip or apex 112 of the scaler 100 is covered by the coating 110.

With respect to an amorphous diamond coating, the coating 110 has a thickness of between about 0.1 μm and about 150 μm. In another embodiment the coating 110 has a thickness of between about 0.5 μm and about 100 μm. In yet another embodiment, the coating 110 has a thickness of between about 5 μm and about 50 μm. Although the above thicknesses are presently preferred it should be appreciated that other thickness may also be used depending upon the application. In addition, with respect to other coatings, these will tend to be slightly thicker in nature than the amorphous diamond coatings.

Depending upon the composition of the coating various techniques may be used to form the coating. For example, in one embodiment, the coating 110 is formed using physical vapor deposition. In another embodiment, the coating 110 is formed using chemical vapor deposition. In another embodiment, the coating 110 is formed using an anodizing process. In another embodiment, the coating 110 is formed using a combination of deposition techniques or anodizing processes.

With respect to an amorphous diamond coating, the coating preferably comprises between about 1 atomic percent hydrogen and about 55 atomic percent hydrogen. In another embodiment, an amorphous diamond coating comprises between about 3 atomic percent hydrogen and about 45 atomic percent hydrogen. In another embodiment, an amorphous diamond coating comprises between about 5 atomic percent hydrogen and about 35 atomic percent hydrogen. A diamond-like carbon coating, depending on the deposition conditions and the tribological system, can have different outstanding tribological properties. In one embodiment, a diamond-like carbon coating comprises a hydrogenated amorphous carbon (a-C:H). In another embodiment, a diamond-like carbon coating comprises a hydrogen free tetrahedral amorphous carbon (ta-C).

Amorphous diamond coating, or another reduced friction coating, can be applied to many different types of instruments besides scalers. Such instruments include but are not limited to scalers, files, bits, burrs, reamers, and end mills, as will be described further below. Such instruments can have one or more of the following exemplary surface conditions. For example, the instrument may be formed from a variety of materials, such as, a metallic materials (e.g,. steel, steel alloys, aluminum, titanium, titanium alloys) and/or metal composites. Instruments made of metallic materials may be heat treated, passivated, (e.g., treated or coated in order to reduce the chemical reactivity of a surface, or to protect against contamination, or increase electrical stability). In other embodiments, the tip of the instrument can be roughened. The instrument can be formed in a variety of matters such as casting or machining.

In one embodiment, the tip 112 of the scaler 100 has a smaller diameter tip and longer working length compared with traditional scalers. In this manner, the tip 112 can provide better access to deep probing sites and more efficient subgingival instrumentation. To provide sufficiently rigid at these small diameters, the tip 112 may be coated with a reduced friction coating 110 to impart structural stiffness. In one embodiment the tip 112 the coating comprises an amorphous diamond coating as described above. The coating 110 may therefore impart stiffness and rigidity to the thin tip 112 while maintaining a high aspect ratio.

The coefficient of friction of a reduced friction coating preferably is less than that of a nickel-titanium file, which has a coefficient of friction of approximately 0.4. Accordingly, in some embodiments, a reduced friction coating has a coefficient of friction of less than about 0.4. In some embodiments, a reduced friction coating has a coefficient of friction of less than about 0.3. In one preferred embodiment, the coefficient of friction for these coatings is between about 0.05 to about 0.15.

Periodontal instrumentation preferably effectively removes plaque and calculus, while limiting root surface damage. Attempts to completely remove calculus deposits can require extensive instrumentation and can result in significant amounts of cementum and dentin loss, thereby inducing dentinal hypersensitivity and increased prevalence of pulpitis. One way to limit the likelihood of creating extensive iatrogenic root surface damage during periodontal debridement is to perform a limited number of multiple light overlapping strokes with a scaler to achieve a clean root. A sharp scaler generally is more effective at removing plaque and calculus. The reduced friction coating 110 described above on the scaler tip 112 advantageously protects the tip 112 and helps to maintain the tip sharpness during the functional life of the scaler 100.

The dental scaler 100 with the reduced friction coating 110 can also reduce the transmission of unwanted bacteria and viruses. Metals by nature are hydrophilic, which can make cleaning difficult, however, in one embodiment, the coating 110 preferably is hydrophobic. In one embodiment, biological tissue does not adhere to a hydrophobic coating, so bacteria and viruses are not readily able to cling to the surface of the scaler 100. In particular, the amorphous diamond coating 110 has a relatively low coefficient of friction, and thus has a lower affinity to have plaque adherence to the surface compared to uncoated stainless steel tip scalers and diamond impregnated dust scalers. The surface of a diamond impregnated dust scaler is especially prone to having plaque adhere between the diamond dust particles, making the cleaning of the instrument difficult between the patients.

In one embodiment, the coated scaler 100 is laser etched along the tip to provide visual indicial that indicates to the dental provider how deep the scaler 100 has gone into the bone or periodontal pocket. The coating 110 advantageously can also provide a dark background against which white laser etched depth markings are visible. For example, in one embodiment, white laser etched marks provide excellent visibility against the black background of the coating 110 along the axial length of the cutting edge 108 of the scaler 100. The coating 110 can also provide a visual indication of when to change the scaler. That is, as the coating 110 wears off, the underlying metal becomes visible indicating that the scaler 100 should be replaced.

Another advantage the illustrated embodiments is that about 10% of the population is allergic or sensitive to nickel. The coating 110 preferably prevents or reduces the likelihood of a patient having an adverse reaction to a dental instrument comprising nickel.

### II. Reduced Friction Coated Endodontic Instruments

Endodontic instruments, e.g., files, bits, burrs, reamers, and end mills, can be used for root canal procedures and/or for forming dental implants. These endodontic instruments are typically made out of nickel titanium and/or stainless steel. Both of these materials have a high coefficient of friction. In some cases, the high coefficient of friction causes the apical portion of small diameter instruments to get stuck inside the root canal. The instruments can break in the middle, exhibiting green stick fracture. This can happen when a handpiece is applying torque to the tip of the instrument, while the apical portion is jammed inside the root canal because of tapering nature of root canal. Additionally, use of the instruments in the preparation of root canals can generate heat.

As explained below, an endodontic instrument, e.g., a file, a gates-glidden burr, has a cutting edge coated with reduced friction coating, such as, an amorphous diamond coating. The instrument preferably is adapted for removing pulp material from a tooth.

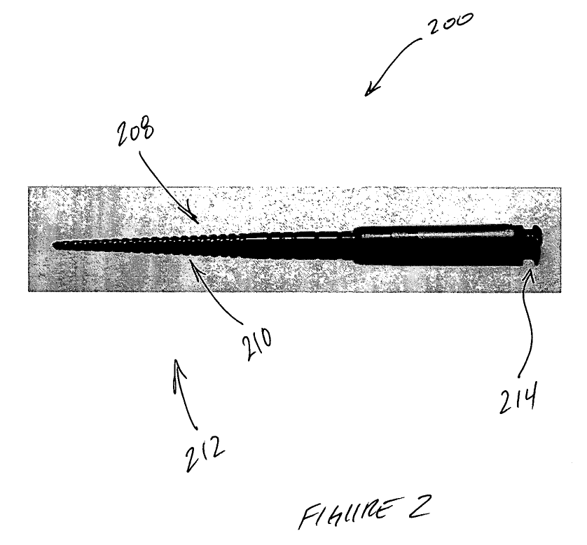

FIG. 2 is an exemplary embodiment of such an endodontic instrument. Specifically, FIG. 2 illustrates an exemplary dental file 200 having a length corresponding to at least the combined length of an operative coronal portion and an operative middle portion of a tooth. The file 200 preferably has a handpiece (not shown), an apical portion 212, and a cutting portion 208 on the apical portion 212.

In one technique, the file 200 is inserted into the operative coronal portion and the operative middle portion of the tooth. Pulp material is removed from the operative coronal portion and the operative middle portion by flexing the file 200 to urge the cutting portion 208 of the instrument against root canal surfaces.

The apical portion 212 preferably is coated with a reduced friction coating 210. In one embodiment, the coating 210 covers at least the apical portion 212. In some embodiments, the coating 210 can cover a length of the instrument between the apical portion 212 and a latch connection 214 generally opposite the apical portion 212, e.g., from the apical portion 212 to the latch connection 214. The latch connection 214 preferably is configured to be coupled to the handpiece. In some embodiments, providing a coating 210 on the latch connection 214 can reduce the chance that the file 200 will get stuck inside the handpiece.

In one embodiment, the coating 210 is an amorphous diamond coating. In other embodiments, another suitable reduced friction coating 210 can be used, such as, for example, those described above with reference to FIG. 1. For example, in one embodiment, a physical vapor deposition technique is used to sputter coat the file with gold particles. In another embodiment, the file is placed in an anodizing bath to coat the file with a hard type II anodized coating. In this type of coating, the instrument preferably is lowered in an anodizing bath, and a layer of oxide with special friction reducing properties is grown.

The coefficient of friction of a reduced friction coating preferably is less than that of a nickel-titanium file which has a coefficient of friction of approximately 0.4. Accordingly, in some embodiments, a reduced friction coating has a coefficient of friction of less than about 0.4. In some embodiments, a reduced friction coating has a coefficient of friction of less than about 0.3. In some embodiments, a reduced friction coating has a coefficient of friction of less than about 0.2. In some embodiments, a reduced friction coating has a coefficient of friction between about 0.05 and about 0.3. In some embodiments, a reduced friction coating has a coefficient of friction between about 0.05 and about 0.15. In one preferred embodiment, the coefficient of friction for these coatings is about 0.1.

The reduced friction coating 210 can prevent or minimize the fracture of endodontic instruments. Files 200 that are coated with a reduced friction coating 210 will advantageously be less likely to break during a procedure because reducing the coefficient of friction makes it less likely that the instrument will get stuck inside the root canal. Reduced friction coatings 210 can also reduce the temperature rise inside the pulp to prevent or limit temperature damage to the tissues. In one embodiment, a dental tool having a coating, e.g., a diamond-like carbon coating, has a high thermal conductivity. The coating decreases wear significantly by rapid transfer of heat from hot spots caused by localized frictional heating. In one embodiment, a diamond-like carbon coating has a coefficient of friction of between about 0.05 and about 0.15. In another embodiment, the coefficient of friction can be greater than about 0.15. In another embodiment, the coefficient of friction can be less than about 0.05. In one embodiment, the coating on the tool acts to minimize frictional wear.

In one embodiment, the coating process preferably involves coating endodontic files with amorphous diamond using a filtered cathodic arc plasma source. In one embodiment, an amorphous diamond coating applied to the cutting edge 208 of the file 200 has at least about 30 percent sp3 carbon bonding, a hardness of at least about 35 gigapascals and a modulus of at least about 300 gigapascals. In one embodiment, an amorphous diamond coating applied to the cutting edge 208 of the file 200 has at least about 40 percent sp3 carbon bonding, a hardness of at least about 45 gigapascals and a modulus of at least about 400 gigapascals. The file 200 can be mechanically honed before coating. In one embodiment, there is no interlayer between the substrate and the amorphous diamond coating. In other embodiments an interlayer can be provided.

Dental providers typically use endodontic files multiple times. As described above with reference to dental scalers, application of a coating to the instrument provides a visual indicator that it is time to change the files as the coating wears off.

### III. Reduced Friction Coated Burrs

Dental burrs and end mills are also used in dental procedures, ENT applications, and orthopedic surgery. For example, dental burrs, and end mills, can be used to cut dentin and prepare dental implants, e.g., titanium dental implants. Dental burrs and end mills can be made out of cemented carbide applied on top of stainless steel substrata. Surface-coated cemented carbides are generally poor conductors of heat. During use, high temperatures can cause the cemented carbide and stainless steel to debond.

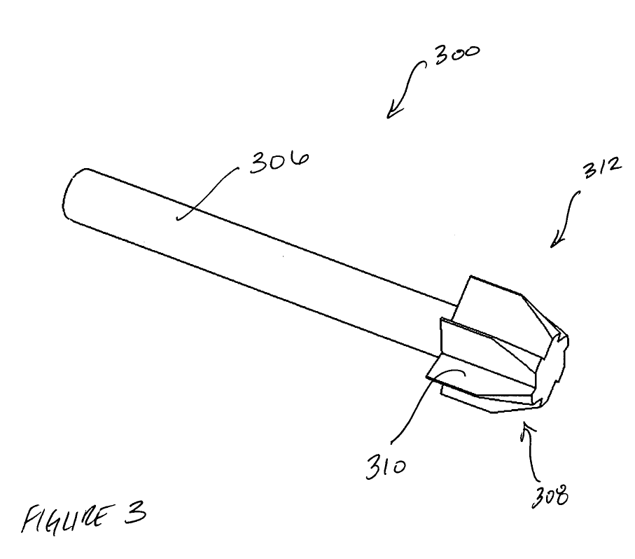

FIG. 3 shows an exemplary burr 300 with a shaft 306 and an apical portion 312. The apical portion 312 can have different cutting configurations 308 in modified embodiments as will be appreciated by those of skill in the art. For example, the apical portion 312 can have a round burr, end mill, twist drill, cylindrical cutting, or other cutting end 308 configurations. The apical portion 312 preferably is coated with a reduced friction coating 310, such as, for example, an amorphous diamond coating as described above. Other coatings, such as those described herein, can also be used. The shaft 306 can also be coated to minimize the chances of the burr 300 getting stuck inside a handpiece (not shown). The material of the burr can be stainless steel, steel with impregnated carbide or any other suitable material.

The amorphous diamond coating advantageously has a high coefficient of thermal conductivity. Accordingly, the risk for debonding between the cemented carbide and stainless steel is reduced. Additionally, the amorphous diamond coated tool has enhanced strength and toughness, as well as enhanced wear resistance, due to lubricious nature of the hard amorphous diamond coated film. A dental burr that has an amorphous diamond coating can also conduct heat away from the patient and can thus reduce the increase in temperature and reduce the likelihood of thermal bone necrosis.

As mentioned above, in other embodiments, the instrument is coated with other types of coatings that can be utilized to minimize the coefficient of friction. For example, tools can be coated with reduced friction coatings such as type II anodized coating or sputter coated gold coating. The coefficient of friction of cemented carbide is approximately 0.5. Accordingly, in some embodiments, a reduced friction coating has a coefficient of friction of less than about 0.5. In some embodiments, a reduced friction coating has a coefficient of friction of less than about 0.4. In some embodiments, a reduced friction coating has a coefficient of friction of less than about 0.3. In some embodiments, a reduced friction coating has a coefficient of friction of less than about 0.2. In some embodiments, a reduced friction coating has a coefficient of friction between about 0.05 and about 0.3. In some embodiments, a reduced friction coating has a coefficient of friction between about 0.05 and about 0.15. In a presently preferred embodiment, the coefficient of friction of these coatings is about 0.1.

Coating the cemented carbide tooling with diamond coating, or another suitable coating, advantageously enhances the longevity of the tool. Additionally, most dental providers use dental burrs multiple times. As the diamond coating wears off, the color of the burr changes from black to silver, providing a visual indicator that it is time to change the burr.

In another embodiment, an instrument comprises an elongate rotary cutting member. The cutting member has an axially forward cutting surface, a flute, and a fluted land. The cutting member preferably comprises a deposited amorphous diamond coating or other friction reducing coating on top of a carbide and/or stainless steel tooling. The deposited amorphous diamond coating preferably is bonded to the substrate and has an average thickness of between about 2 micrometers and about 100 micrometers. In some embodiments, other tools can be coated for use in dental, orthopedic or ENT applications.

The various devices, methods and techniques described above provide a number of ways to carry out the invention. Of course, it is to be understood that not necessarily all objectives or advantages described may be achieved in accordance with any particular embodiment described herein. It will be understood that the foregoing is only illustrative of the principles of the invention, and that various modifications, alterations, and combinations can be made by those skilled in the art without departing from the scope and spirit of the invention.

1. A dental instrument, comprising:
an elongate dental tool having a proximal portion, a distal portion, and a cutting portion located near the distal portion; and
a reduced friction coating applied to the elongate dental tool at least at the cutting portion.

2. The dental instrument of claim 1, wherein the elongate dental tool is a scaler.

3. The dental instrument of claim 1, wherein the elongate dental tool is a file.

4. The dental instrument of claim 1, wherein the elongate dental tool is a bit.

5. The dental instrument of claim 1, wherein the elongate dental tool is a burr.

6. The dental instrument of claim 1, wherein the elongate dental tool is a reamer.

7. The dental instrument of claim 1, wherein the elongate dental tool is an end mill.

8. The dental instrument of claim 1, wherein the elongate dental tool is hand-driven.

9. The dental instrument of claim 1, wherein the elongate dental tool is mechanically-driven.

10. The dental instrument of claim 1, wherein the elongate dental tool comprises a handpiece near a proximal portion.

11. The dental instrument of claim 1, wherein the elongate dental tool is coupled with a handpiece near a proximal portion.

12. The dental instrument of claim 1, wherein the distal portion comprises a latch connection.

13. The dental instrument of claim 1, wherein the proximal portion has a diameter sized to fit within a periodontal pocket between a tooth and surrounding gum and bone.

14. The dental instrument of claim 1, wherein the proximal portion has a diameter of less than or equal to about 0.014 inches.

15. The dental instrument of claim 1, wherein the proximal portion has a diameter of greater than or equal to about 0.0065 inches.

16. The dental instrument of claim 1, wherein at least a portion of the elongate dental tool has a generally conical shape.

17. The dental instrument of claim 1, wherein the reduced friction coating is applied to a length of the elongate dental tool between the proximal end and the distal end.

18. The dental instrument of claim 1, wherein the reduced friction coating is marked with indicia.

19. The dental instrument of claim 1, wherein the reduced friction coating has an average thickness of between about 0.1 μm and about 150 μm.

20. The dental instrument of claim 19, wherein the reduced friction coating has an average thickness of between about 0.5 μm and about 100 μm.

21. The dental instrument of claim 20, wherein the reduced friction coating has an average thickness of between about 5 μm and about 50 μm.

22. The dental instrument of claim 1, wherein the reduced friction coating has a coefficient of friction of less than about 0.5.

23. The dental instrument of claim 22, wherein the reduced friction coating has a coefficient of friction of less than about 0.4.

24. The dental instrument of claim 23, wherein the reduced friction coating has a coefficient of friction of less than about 0.3.

25. The dental instrument of claim 24, wherein the reduced friction coating has a coefficient of friction of less than about 0.2.

26. The dental instrument of claim 25, wherein the reduced friction coating has a coefficient of friction of about 0.1.

27. The dental instrument of claim 1, wherein the reduced friction coating has a coefficient of friction of between about 0.05 and about 0.3.

28. The dental instrument of claim 27, wherein the reduced friction coating has a coefficient of friction of between about 0.05 and about 0.15.

29. The dental instrument of claim 1, wherein the reduced friction coating comprises a Teflon coating.

30. The dental instrument of claim 1, wherein the reduced friction coating comprises a ME-92 coating.

31. The dental instrument of claim 1, wherein the reduced friction coating comprises a sputter gold coating.

32. The dental instrument of claim 1, wherein the reduced friction coating comprises a hard type II anodized coating.

33. The dental instrument of claim 1, wherein the reduced friction coating comprises an amorphous diamond coating.

34. The dental instrument of claim 33, wherein the amorphous diamond coating comprises between about 1 atomic percent hydrogen and about 55 atomic percent hydrogen.

35. The dental instrument of claim 34, wherein the amorphous diamond coating comprises between about 3 atomic percent hydrogen and about 45 atomic percent hydrogen.

36. The dental instrument of claim 35, wherein the amorphous diamond coating comprises between about 5 atomic percent hydrogen and about 35 atomic percent hydrogen.

37. The dental instrument of claim 33, wherein the amorphous diamond coating comprises at least about 30 percent sp3 carbon bonding.

38. The dental instrument of claim 37, wherein the amorphous diamond coating comprises at least about 40 percent sp3 carbon bonding.

39. The dental instrument of claim 33, wherein the amorphous diamond coating comprises a hardness of at least about 35 gigapascals and a modulus of at least about 300 gigapascals.

40. The dental instrument of claim 39, wherein the amorphous diamond coating comprises a hardness of at least about 45 gigapascals and a modulus of at least about 400 gigapascals.

41. The method for treating a patient, comprising:
providing an elongate dental tool having a proximal portion, a distal portion, and a cutting portion having a reduced friction coating applied to at least the cutting portion; and
inserting the elongate dental tool into the mouth of the patient to perform a dental procedure.

42. The method of claim 41, wherein the dental procedure comprises cleaning the teeth of the patient.

43. The method of claim 41, wherein the dental procedure comprises performing a root canal on a tooth of the patient.

44. The method of claim 41, wherein the dental procedure comprises preparing a dental implant.

45. The method for making a dental instrument, comprising:
providing an elongate dental tool having a proximal portion, a distal portion, and a cutting portion; and
applying a reduced friction coating to at least the cutting portion.

46. The method of claim 45, additionally comprising heat treating the elongate dental tool.

47. The method of claim 45, additionally comprising passivating the elongate dental tool.

48. The method of claim 45, additionally comprising roughening the elongate dental tool.

49. The method of claim 45, additionally comprising etching the reduced friction coating.

50. The method of claim 45, wherein applying the reduced friction coating comprises using physical vapor deposition.

51. The method of claim 45, wherein applying the reduced friction coating comprises using chemical vapor deposition.

52. The method of claim 45, wherein applying the reduced friction coating comprises using an anodizing process.
